(19) United States
(12) Patent Application Publication
(10) Pub. No.: US 2010/0156902 A1
(43) Pub. Date: Jun. 24, 2010

(54) METHOD AND APPARATUS FOR GENERATING GRAPHIC HAIR MOTION

(75) Inventors: Myunggyu Kim, Daejeon (KR); Il-Kwon Jeong, Daejeon (KR); Byoung Tae Choi, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/491,020

(22) Filed: Jun. 24, 2009

(30) Foreign Application Priority Data
Dec. 22, 2008 (KR) 10-2008-0130778

(51) Int. Cl. G06T 17/00; G06T 15/70

(52) U.S. Cl. 345/420; 345/474

(57) ABSTRACT

The present invention provides a graphic motion generating method and apparatus for modeling hair into elastic curves that are inextensible while twisting and curling of hair can be expressed, for applying an adaptive different subdividing method to subdivide a single strand of hair into several segments such that detailed bending and curling of the strands of hair can be expressed in the vicinities of roots and ends of the strands of hair, for modeling the respective segments of respective strands of hair into low degree-of-freedom elastic curves with degrees of freedom less than two such that geometric and dynamic physical quantities can be calculated in a short time, and for automatically generating a curvature vector of the elastic curve model from an initial hair curve by using a minimizing technique.

### CROSS-REFERENCE(S) TO RELATED APPLICATION(S)

The present invention claims priority of Korean Patent Application No. 10-2008-0130778, file on Dec. 22, 2008, which is incorporated herein by reference.

### FIELD OF THE INVENTION

The present invention relates to a method and an apparatus for generating a graphic hair motion and, more particularly, to a method and an apparatus for generating a graphic hair motion with high quality and effective speed in visualizing a shape and motion of hair in computer graphics.

### BACKGROUND OF THE INVENTION

As well known to one skilled in the art, there is a mass-spring model in which the number of material points and the nearest material point are connected to each other with springs in respective strands of hair. According to the mass-spring model, hair is implemented in a very simple and rapid fashion.

After the above-mentioned proposal, Hadap has proposed a rigid multi-body linear chain model based on a rigid multi-body model used in robotics and articulated object animation. In this model, respective hair strands are approximated into linear rigid multi-bodies so that a dynamic engine can be easily modified to use and hair does not extend.

Recently, an elastic curve hair model is proposed and its researches are being widely conducted. Moreover, Bertails proposed a model of discrete Kirchhoff's theory for elastic rods used in mechanical engineering. In the Bertails model, a strand of hair is subdivided into segments with same length and the respective segments are modeled in helix type. The Bertails model can provide the expression of hair curling in inextensible strands of hair.

However, in the above-mentioned mass-spring model, overall strands of hair are extended when the spring is extended and curling cannot be expressed sufficiently. In order to solve these problems, several modified mass-spring models are proposed to connect the material points and a not-nearest material point with springs. However, even in the new models, the extension of strands of hair and insufficient curling expression of hair cannot be solved.

Next, Hadap model is applied to only straight hair because of being unable to express curl hair curling which requires the expression of hair curling.

Since the Bertails model uses an equal-length subdividing method when subdividing hairs into segments, it is not sufficient to express reality of hair strands ends which are more bent in the ends than in the roots of the hair strands. Further, there are great deals of vectors and matrices to be calculated for simulating the hair strands using high degree of freedom thereby spending a long time. Moreover, there is no way of automatically generating variables of a model curve from an initial three-dimension (3D) curve.

### SUMMARY OF THE INVENTION

It is, therefore, an object of the present invention to provide a graphic motion generating method and apparatus for modeling hair into elastic curves that are inextensible while twisting and curling of hair can be expressed, for applying an adaptive different subdividing method to subdivide a single strand of hair into several segments such that detailed bending and curling of the strands of hair can be expressed in the vicinities of roots and ends of the strands of hair, for modeling the respective segments of respective strands of hair into low degree-of-freedom elastic curves with degrees of freedom less than two such that geometric and dynamic physical quantities can be calculated in a short time, and for automatically generating a curvature vector of the elastic curve model from an initial hair curve by using a minimizing technique.

In accordance with one aspect of the present invention, there is provided a method for generating a graphic hair motion including: subdividing a strand of hair into N segment curves with lengths (l_{Q}) by using initial curve information of the strand of hair; determining a list of initial curvature vectors (C_{Q}) of the segment curves; generating a list of rotation vectors (Ω_{Q}), a list of rotation matrices (P(Ω_{Q},s)), a list of transition matrices (R(Ω_{Q},s)), and a list of model curves (r^{Q}(s)) based on the list of the curvature vectors; generating lists of composite matrices (U, V, and W) by using the rotation matrices and the transition matrices; determining a list of new curvature vectors (C_{Q}) of a shape of a next frame based on the lists of the composite matrices and an external root motion of hair; and repeatedly performing the generation of another lists of rotation vectors, rotation matrices, transition matrices, and model curves and the determination of a list of new curvature vectors of another next frame to generate a hair curve modified according to time.

It is preferable that the length (l_{Q}) of each of the segment curves is obtained by applying a differential subdividing method which increases reality of the hair by reflecting property of the strand of the hair.

It is preferable that each of the model curves (r^{Q}(s)) is determined by following equation:

t^{Q}(s)=P(Ω_{Q},s)t^{Q-1}(l_{Q-1})

r^{Q}(s)=r^{Q-1}(l_{Q-1})+R(Ω_{Q},s)t^{Q-1}(l_{Q-1}),

where in the Qth segment curve, r^{Q}(s) is a position vector of a model curve, t^{Q}(s) is a tangential vector, R(Ω_{Q},s) is a transition matrix in which P(Ω_{Q},s) is integrated with respect to s, t^{Q-1}(l_{Q-1}) and rt^{Q-1}(l_{Q-1}) are respectively a tangential vector and a position vector at an end point of (Q−1)th segment curve, s position parameter, and l_{Q} is a length of the Qth segment curve.

It is preferable that the property of the strand of hair bending of which is gradually increased as goes from the vicinity of root to end of the strand of the hair.

It is preferable that each of the curvature vectors (C_{Q}) for the determining each of the rotation vectors (Ω_{Q}) has only two or less degrees of freedom such that the model curves (r^{Q}(s)) are modeled into a low degree-of-freedom elastic curve.

It is preferable that the low degree-of-freedom is a Fresnel-Cosserat curve.

It is preferable that the strand of the hair is subdivided into the segment curves such that a segment curve near to a root of the strand is relatively long and a segment curve near to an end of the strand is relatively short.

It is preferable that the composite matrices (U, V, and W) are calculated by differentiating and integrating geometric quantities expressed by the following equation:

$${U}_{α}^{Q} ( s ) = \{ \begin{matrix}\frac{\partial P ( {Ω}_{Q} , s )}{\partial {Ω}_{Q α}} & ( α = 1 , 2 , 3 ) \\ P ( {Ω}_{Q} , s ) & ( α = 4 )\end{matrix} \\ {V}_{α}^{Q} ( s ) = \{ \begin{matrix}\frac{\partial R ( {Ω}_{Q} , s )}{\partial {Ω}_{Q α}} & ( α = 1 , 2 , 3 ) \\ R ( {Ω}_{Q} , s ) & ( α = 4 ) \\ {I}_{3} & ( α = 5 ) ,\end{matrix} \\ where {Ω}_{Q α} \\ {W}_{αβ}^{Q} = {\int }_{0}^{{l}_{Q}} {{V}_{α}^{Q} ( s )}^{T} {V}_{β}^{Q} ( s ) d s \\ ( α , β = 1 , 2 , 3 , 4 , 5 )$$

is α component of a rotation vector Ω_{Q}, P(Ω_{Q},s) is a rotation matrix, R(Ω_{Q},s) is a transition matrix, and I₃ is an identity matrix.

It is preferable that the list of the new curvature vectors (C_{Q}) of said another next frame is determined by using a semi-implicit method in computer graphics.

It is preferable that when the semi-implicit method is used, each of the model curves of a frame at every time is determined by 2N-dimension vector xₜ=(τ₁,κ₁, . . . , τ_{N},κ_{N})ₜ and a curved shape of a strand of hair (x_{t+Δt}) at a time (t+Δt) is obtained from a curved shape of a strand of hair xₜ at a time t through following equation:

x_{t+Δt}=xₜ+Δty_{t+Δt}

yₜ{\dot{τ}₁,\dot{κ}₁, . . . , \dot{τ}_{N},\dot{κ}_{N}},

where Δt is a time interval and yₜ is a differential of xₜ with respect to time t.

It is preferable that the y_{t+Δt} is obtained by solving a linear equation:

Ay_{t+Δt}=Byₜ+fₜ, where matrices A and B may be respectively a mass matrix and a stiffness matrix of (2N)*(2N) matrices calculated using geometric composite matrices, fₜ is a restoring force due to an elastic force of the strand of the hair, an inertial force caused by movement of a root connected to a body of the strand, an external force such as gravity or wind, and a collision force between the hair and the body of the strand or between the hair and another hair, and the composite matrices of claim 9 may be used to calculate (2N) vector fₜ.

It is preferable that an algorithm for solving the linear equation comprises at least one of conjugate gradient (CG) method, Cholesky decomposition (CD), singular value decomposition (SVD), Gauss-Seidel relaxation, a multi-grid algorithm, and a preconditioned conjugate gradient (PCG) method.

It is preferable that the initial curve information of the strand of the hair is three-dimension curve information in a format of a set of M sample points.

It is preferable that the set of the M sample points is generated by at least one of Autodesk MAYA and Shave & Haircut or by an editor program.

It is preferable that in the generating of the list of the initial curvature vectors (C_{Q}), the list of the initial curvature vectors of the N segment curves is obtained from 3M values of initial M sample points by applying a minimizing technique to a difference function g(τ₁,κ₁, . . . , τ_{N},κ_{N}) as expressed by following equation:

$${min}_{\{ {τ}_{1} , {κ}_{1} , … , {τ}_{N} , {κ}_{N} \}} g ( {τ}_{1} , {κ}_{1} , … , {τ}_{N} , {κ}_{N} )$$

$$g ( {τ}_{1} , {κ}_{1} , … , {τ}_{N} , {κ}_{N} ) = {\sum }_{κ = 1}^{M} {\vert r ( {s}_{κ} ) - {r}_{in} ( {s}_{κ} ) \vert}^{2} ,$$

where r(s) and rᵢₙ(s) are a model curve and a sample curve respectively, r(s_{κ})−rᵢₙ(s_{κ}) is an error, and it is understood that sum of square of the error becomes the difference function g(τ₁,κ₁, . . . , τ_{N},κ_{N}).

In accordance with another aspect of the present invention, there is provided an apparatus for generating a graphic hair motion, including: an initializer to determine a list of initial curvature vectors by using curve information of a strand of hair; a kinematics unit to generate a rotation vector, a rotation matrix, a transition matrix, and a model curve; a geometry unit to generate a composite matrix using the rotation matrix and the transition matrix; and a dynamics unit to calculate a list of new curvature vectors of a shape of a next frame based on the composite matrix and an external root motion of hair.

It is preferable that the geometry unit is connected to the kinematics unit and the dynamics unit such that the list of the new curvature vectors determined by the dynamics unit is used by the kinematics unit again and generates a modified hair curve according to time.

According to the present invention, a systemized pipeline for generating hair motion is provided so that manual operation can be miniaturized and calculation process can be effective.

Since hair curves are subdivided differently according to distances from roots of the hair curves, detailed expression of hair is enabled by reflecting phenomena that a small change occurs at the roots and a considerable bending occurs near ends of hair.

Moreover, since a list of initial curvature vectors is automatically generated with respect to a sample input of an arbitrary initial hair curve, user's burden required to use a generalized coordinate model can be eliminated.

Since it is possible to use only degrees of freedom less than two per a segment of a strand of hair, time for calculation can be shortened.

Furthermore, the method and apparatus of the present invention are useful to visualize the motion of hair in a rapid and effective manner and are applied to a physics-based animation of human hair and animal fur in computer graphics resulting in effectively generating a high quality image of the human hair and animal fur.

### BRIEF DESCRIPTION OF THE DRAWINGS

The above and other objects and features of the present invention will become apparent from the following description of embodiments given in conjunction with the accompanying drawings, in which:

FIG. 1 is a block diagram illustrating an apparatus for generating a graphic hair motion according to an embodiment of the present invention;

FIG. 2 is a detailed block diagram illustrating a graphic hair motion-generating unit of FIG. 1;

FIG. 3 is a view illustrating an adaptive differential subdividing method employed in an embodiment of the present invention;

FIG. 4 is a view illustrating a low degree-of-freedom curve modeling having only two degrees of freedom that is employed in an embodiment of the present invention; and

FIG. 5 is a flowchart illustrating a graphic hair motion generating method according to another embodiment of the present invention.

### DETAILED DESCRIPTION OF THE EMBODIMENTS

Hereinafter, embodiments of the present invention will be described in detail with reference to the accompanying drawings.

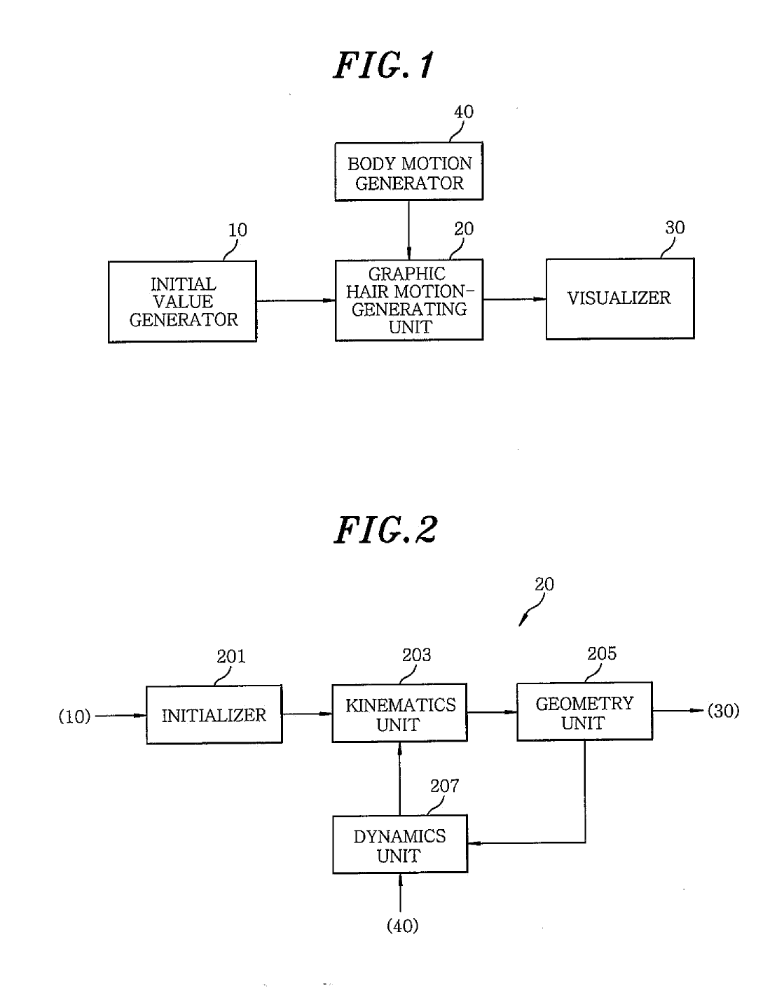

FIG. 1 is a block diagram illustrating a graphic hair motion generating apparatus according to an embodiment of the present invention, and the apparatus may include an initial value generator 10, a graphic hair motion-generating unit 20, a visualizer 30, and a body motion generator 40.

The initial value generator 10 may be an editor program providing initial shapes of strands of hair and using any one of Autodesk MAYA and Shave & Haircut as commercial programs or a new program. The initial value generator 10 may provide three-dimension (3D) curve information in the format of a set of M sample points expressed by the following equation 1 from initial strands of hair for the graphic hair motion-generating unit 20.

rᵢₙ(s):{x₁,y₁,z₁, . . . , x_{M},y_{M},z_{M}}, [Equation 1]

where rᵢₙ(s) is a set of sample points and M is the number of sample points.

The graphic hair motion-generating unit 20, as illustrated in FIG. 2, may include an initializer 201, a kinematics unit 203, a geometry unit 205, and a dynamics unit 207.

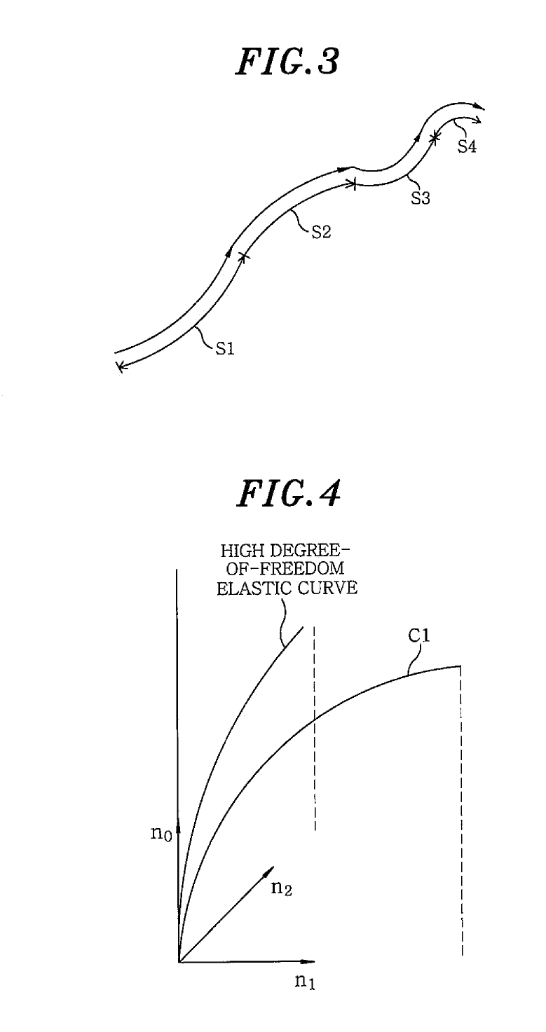

The initializer 201 subdivides a single strand of hair into N segment curves by using the 3D curve information input from the initial value generator 10. As illustrated in FIG. 3, a segment curve S1 near to a root of the hair strand is relatively long and a segment curve S4 near to an end of the hair strand is relatively short (i.e., as illustrated in FIG. 3, respective lengths of the segment curves are S1>S2>S3>S4) by the differential subdividing method. A length 1_{Q} of Qth segment curve can be obtained from the following equation 2.

$${l}_{Q} = l ( 1 - \frac{Q - 1}{3 ( N - 1 )} ) , \\ l = 1.2 \frac{L}{N} ( Q = 1 , … , N ) , \qquad [ Equation 2 ]$$

where L is an overall length of a strand of hair, N is the number of segment curves of hair strand, and Q is a Qth segment curve of the hair strand.

Here, the differential subdividing method is a hair expression method of improving reality of hair by reflecting properties of strands of real hair bending of which is gradually increased as goes from the vicinity of roots to ends of the strands of hair.

The initializer 201 models the Qth segment curves of the respective hair strands which are obtained by the above-mentioned manner into Fresnel-Cosserat curves as low degree-of-freedom elastic curves thicknesses of which may be almost ignored, twist and curling of which can be expressed, and which are not extensible, as illustrated in FIG. 4 thereby to determine curvature vectors C_{Q} as the following equation 3.

C_{Q}={τ_{Q},κ_{Q}} [Equation 3]

where τ_{Q} is torsion describing twist and κ_{Q} is curvature describing curling. Here, since only degrees of freedom per a segment curve of strands equal to or less than two is used, time for calculation can be shortened.

The kinematics unit 203 uses the lengths l_{Q} of the Qth segment curve obtained by equation 2 and simulation parameters to calculate constants such as stiffness matrix.

The kinematics unit 203 calculates a list of rotation vectors Ω_{Q} based on a list of curvature vector C_{Q} at every frame input from the initializer 201 or the dynamics unit 207, and calculates a list of rotation matrices P_{Ω}_{_{Q}},s and a list of transition matrices RΩ_{Q},s based on the list of the rotation vectors Ω_{Q}.

The kinematics unit 203 determines model curves r^{Q}(s) of the Qth segment curves by using the following equation 4 with the rotation matrices P_{Ω}_{_{Q}},s and the transition matrices RΩ_{Q},s, and provides the model curves For the visualizer 30 of FIG. 1 via the geometry unit 204 of FIG. 2.

t^{Q}(s)=P(Ω_{Q},s)t^{Q-1}(l_{Q-1})

r^{Q}(s)=rt^{Q-1}(l_{Q-1})+R(Ω_{Q},s)t^{Q-1}(l_{Q-1}) [Equation 4]

where, in the Qth segment curve, r^{Q}(s) is a position vector of a model curve, t^{Q}(s) is a tangential vector, R(Ω_{Q},s) is a transition matrix in which P(Ω_{Q},s) is integrated with respect to s, t^{Q-1}(l_{Q-1}) and rt^{Q-1}(l_{Q-1}) are respectively a tangential vector and a position vector at an end point of (Q−1)th segment curve, that is, at a starting point of the Qth segment curve, s is a position parameter, and l_{Q} is a length of the Qth segment curve.

Although the list of curvature vectors C_{Q} input from the dynamics unit 207 to the kinematics unit 203 is changed at every frame, the list of curvature vectors input from the initializer 201 is determined only once. To this end, calculating from values of 3M variables in the set consisting of M sample points in equation 1 that values of 2N variables constituting with respect to N segment curves, is carried out only once. For this calculation, a minimizing technique is applied to a difference function g(τ₁,κ₁, . . . , τ_{N},κ_{N}), that is, the following equation 5 is solved.

$${min}_{\{ {τ}_{1} , {κ}_{1} , … , {τ}_{N} , {κ}_{N} \}} g ( {τ}_{1} , {κ}_{1} , … , {τ}_{N} , {κ}_{N} ) \\ g ( {τ}_{1} , {κ}_{1} , … , {τ}_{N} , {κ}_{N} ) = {\sum }_{κ = 1}^{M} {\vert r ( {s}_{κ} ) - {r}_{in} ( {s}_{κ} ) \vert}^{2} \qquad [ Equation 5 ]$$

where r(s) and rᵢₙ(s) are a model curve and a sample curve respectively, r(s_{κ})−rᵢₙ(s_{κ}) is an error, and it is understood that sum of square of error becomes the difference function g(τ₁,κ₁, . . . , τ_{N},κ_{N}).

The geometry unit 205 calculates composite matrices U, V, and W, as expressed by equation 6, through differentiating and integrating geometric quantities by using the list of rotation matrices P(Ω_{Q},S) and the list of transition matrices R(Ω_{Q},s) which are at every frame input from the kinematics unit 203, and provides the composite matrices U, V, and W for the dynamics unit 207.

$${U}_{α}^{Q} ( s ) = \{ \begin{matrix}\frac{\partial P ( {Ω}_{Q} , s )}{\partial {Ω}_{Q α}} & ( α = 1 , 2 , 3 ) \\ P ( {Ω}_{Q} , s ) & ( α = 4 )\end{matrix} \\ {V}_{α}^{Q} ( s ) = \{ \begin{matrix}\frac{\partial R ( {Ω}_{Q} , s )}{\partial {Ω}_{Q α}} & ( α = 1 , 2 , 3 ) \\ R ( {Ω}_{Q} , s ) & ( α = 4 ) \\ {I}_{3} & ( α = 5 )\end{matrix} \\ {W}_{αβ}^{Q} = {\int }_{0}^{{l}_{Q}} {{V}_{α}^{Q} ( s )}^{T} {V}_{β}^{Q} ( s ) d s \\ ( α , β = 1 , 2 , 3 , 4 , 5 ) \qquad [ Equation 6 ]$$

where Ω_{Qα} is α component of a rotation vector Ω_{Q}, P (Ω_{Q},S) is a rotation matrix, R(Ω_{Q},s) is a transition matrix, and I₃ is an equivalent matrix.

The dynamics unit 207 uses the composite matrices as outputs from the geometry unit 205 and a root motion of hair input from the body motion generator 40, that is, a curved shape of a frame at the current time to determine a shape of hair at a next time frame. In more detail, although the shape of hair must be determined in principle through a non-linear differential equation for expressing a motion derived from a physical model of a hair motion, since the non-linear differential equation is possible to obtain an analytical solution in only a special simple mechanical system, only shapes of hair at discrete time are determined by numerically approximating the shapes of hair into non-linear discrete equation. In applications of computer graphics, since a discrete method performed within a short time is allowed to use regardless of inferior precision, a physical motion non-linear differential equation is simplified into a linear discrete equation for the graphics animation application so that the shapes of hair can be determined.

In this case, a semi-implicit method is used as a discrete method and a model curve of a frame at every time is determined by 2N-dimension vector xₜ=(τ₁,κ₁, . . . , τ_{N},κ_{N})ₜ and a curved shape of a strand of hair (x_{t+Δt}) at a time (t+Δt) is obtained from a curved shape of a strand of hair xₜ at a time t through the following equation 7.

x_{t+Δt}=xₜ+Δty_{t+Δt}

yₜ={\dot{τ}₁,\dot{κ}₁, . . . , \dot{τ}_{N},\dot{κ}_{N}}ₜ [Equation 7]

where Δt is a time interval and yₜ is a differential of xₜ with respect to time t.

yₜ+Δₜ of equation 7 is obtained by solving a linear equation, that is, equation 8.

Ay_{t+Δt}=Byₜ+fₜ [Equation 8]

where matrices A and B may be respectively a mass matrix and a stiffness matrix of (2N)*(2N) matrices calculated using the composite matrices that are calculated in equation 6 by the geometry unit 205, fₜ is a restoring force due to an elastic force of a strand of hair, an inertial force caused by movement of a root connected to a body of the strand of hair, an external force such as gravity or wind, and a collision force between hair and the body of the strand or between hair and hair, and in order to calculate (2N) vector fₜ, the geometric composite 3*3 matrices calculated by the geometry unit 205 through equation 6 may be used.

Moreover, although any one of algorithms such as conjugate gradient (CG) method, Cholesky decomposition (CD), singular value decomposition (SVD), Gauss-Seidel relaxation, and a multi-grid algorithm may be used to solve the linear equation given by equation 8, a preconditioned conjugate gradient (PCG) method of using yₜ as an early estimation of y_{t+Δt} is an effective method in the present invention.

Therefore, according to the present invention, a systemized pipeline for generating hair motion is provided so that manual operation can be miniaturized and calculation process can be effective. Since hair curves are subdivided differently according to distances from roots of the hair curves, detailed expression of hair is enabled by reflecting phenomena that a small change occurs at the roots and a considerable bending occurs near ends of hair.

Next, a graphic hair motion-generating procedure performed by the graphic hair motion generating apparatus constructed as described above will be described.

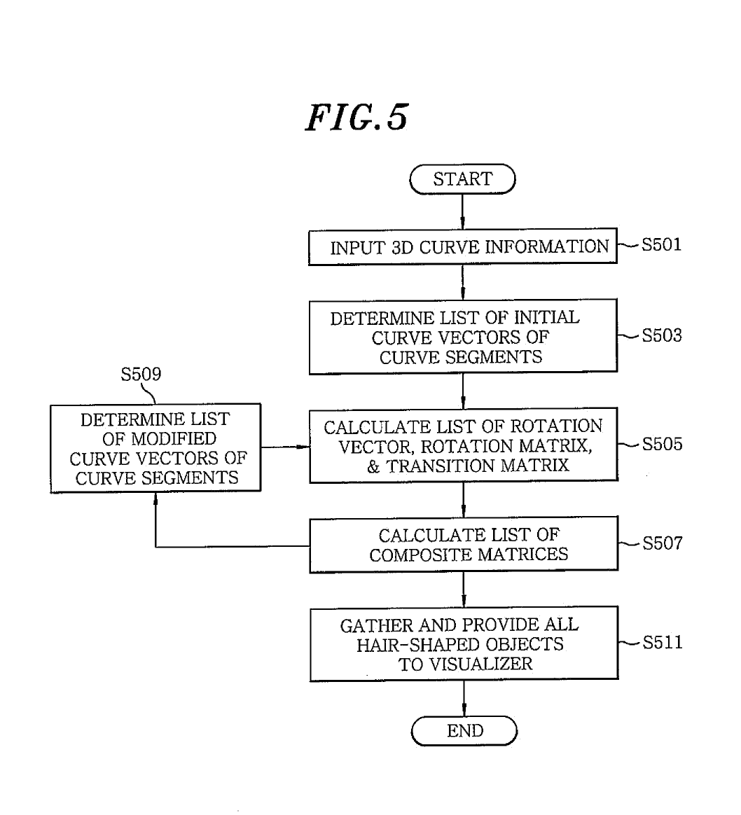

FIG. 5 is a flowchart illustrating a graphic hair motion generating method according to another embodiment of the present invention.

The initializer 201 of the graphic hair motion-generating unit 20 receives 3D curve information of initial strands of hair, which are generated by the initial generator 10, in the format of a set of M sample points expressed by equation 1 (S501). The initializer 201 subdivides a single strand of hair into N segment curves using the received 3D curve information such that a segment curve near to a root of the hair strand is relatively long and a segment curve near to an end of the hair strand is relatively short. The initializer 201 obtains a length l_{Q} of Qth segment curves from equation 2 and models the obtained segment curved of the strand into Fresnel-Cosserat curve as low degree-of-freedom elastic curves as illustrated in FIG. 4. The initializer 201 determines a list of curvature vectors C_{Q} for describing a shape of the Qth segment curve by solving equation 5 (S503) and provides the determined list of curvature vectors C_{Q} for the kinematics unit 203.

The kinematics unit 203 determines a list of rotation vectors Ω_{Q} based on the list of curvature vectors C_{Q} input from the initializer 201 or the dynamics unit 207 and calculates lists of rotation matrices P(Ω_{Q},S) and transition matrices R(Ω_{Q},s) based on the list of rotation vectors Ω_{Q},S (S505) to provide the calculated lists to the geometry unit 205.

The geometry unit 205 calculates composite matrices (S507) to be used in the dynamics unit 207 through differentiating and integrating geometric quantities expressed by equation 6 using the list of rotation matrices P(Ω_{Q},s) and the list of transition matrices R(Ω_{Q},s) which are at every frame input from the kinematics unit 203 and provides the calculated composite matrices for the dynamics unit 207. The geometry unit 205 provides a modified hair model curve r^{Q}(s) obtained from equation 4 for the visualizer 30 (S511) finally.

The dynamics unit 207 uses the composite matrices received from the geometry unit 205 and a root motion of hair input received from the body motion generator 40, that is, a curved shape of a frame at the current time to determine a list of new curvature vectors as a shape of hair at a next time frame (S509) and provides the determined list to the kinematics unit 203. In other words, the output of the dynamics unit 207 is used again by the kinematics unit 203 like in the graphic hair motion generator 20. That is, the output of the dynamics unit 207 circulates a loop connecting the kinematics unit 203, the geometry unit 205, and the dynamics unit 207 and is used to generate the shape of hair with respect to continuous-time frames.

As described above, since a list of initial curvature vectors is automatically generated with respect to a sample input of an arbitrary initial hair curve, user's burden required to use a generalized coordinate model can be eliminated. It is possible to use only degrees of freedom less than two per a segment of a strand of hair so that time for calculation can be shortened. Moreover, the method and apparatus of the present invention are useful to visualize the motion of hair in a rapid and effective manner and are applied to a physics-based animation of human hair and animal fur in computer graphics resulting in effectively generating a high quality image of the human hair and animal fur.

While the invention has been shown and described with respect to the embodiments, it will be understood by those skilled in the art that various changes and modifications may be made without departing from the scope of the invention as defined in the following claims.

What is claimed is:

1. A method for generating a graphic hair motion comprising:
subdividing a strand of hair into N segment curves with lengths (l_{Q}) by using initial curve information of the strand of hair;
determining a list of initial curvature vectors (C_{Q}) of the segment curves;
generating a list of rotation vectors (Ω_{Q}), a list of rotation matrices (P(Ω_{Q},s)), a list of transition matrices (R(Ω_{Q},s)), and a list of model curves (r^{Q}(s)) based on the list of the curvature vectors;
generating lists of composite matrices (U, V, and W) by using the rotation matrices and the transition matrices;
determining a list of new curvature vectors (C_{Q}) of a shape of a next frame based on the lists of the composite matrices and an external root motion of hair; and
repeatedly performing the generation of another lists of rotation vectors, rotation matrices, transition matrices, and model curves and the determination of a list of new curvature vectors of another next frame to generate a hair curve modified according to time.

2. The method of claim 1, wherein the length (l_{Q}) of each of the segment curves is obtained by applying a differential subdividing method which increases reality of the hair by reflecting property of the strand of the hair.

3. The method of claim 1, wherein each of the model curves (r^{Q}(s)) is determined by following equation:
t^{Q}(s)=P(Ω_{Q},s)t^{Q-1}(l_{Q-1})
r^{Q}(s)=rt^{Q-1}(l_{Q-1})+R(Ω_{Q},s)t^{Q-1}(l_{Q-1})
where, in the Qth segment curve, r^{Q}(s) is a position vector of a model curve, t^{Q}(s) is a tangential vector, R(Ω_{Q},s) is a transition matrix in which P(Ω_{Q},s) is integrated with respect to s, t^{Q-1}(l_{Q-1}) and rt^{Q-1}(l_{Q-1}) are respectively a tangential vector and a position vector at an end point of (Q−1)th segment curve, s is position parameter, and l_{Q} is a length of the Qth segment curve.

4. The method of claim 2, wherein the property of the strand of hair bending of which is gradually increased as goes from the vicinity of root to end of the strand of the hair.

5. The method of claim 3, wherein each of the curvature vectors (C_{Q}) for the determining each of the rotation vectors (Ω_{Q}) has only two or less degrees of freedom such that the model curves (r^{Q}(s)) are modeled into a low degree-of-freedom elastic curve.

6. The method of claim 5, wherein the low degree-of-freedom is a Fresnel-Cosserat curve.

7. The method of claim 2, wherein the strand of the hair is subdivided into the segment curves such that a segment curve near to a root of the strand is relatively long and a segment curve near to an end of the strand is relatively short.

8. The method of claim 1, wherein the composite matrices (U, V, and W) are calculated by differentiating and integrating geometric quantities expressed by the following equation:
$${U}_{α}^{Q} ( s ) = \{ \begin{matrix}\frac{\partial P ( {Ω}_{Q} , s )}{\partial {Ω}_{Q α}} & ( α = 1 , 2 , 3 ) \\ P ( {Ω}_{Q} , s ) & ( α = 4 )\end{matrix} \\ {V}_{α}^{Q} ( s ) = \{ \begin{matrix}\frac{\partial R ( {Ω}_{Q} , s )}{\partial {Ω}_{Q α}} & ( α = 1 , 2 , 3 ) \\ R ( {Ω}_{Q} , s ) & ( α = 4 ) \\ {I}_{3} & ( α = 5 )\end{matrix} \\ {W}_{αβ}^{Q} = {\int }_{0}^{{l}_{Q}} {{V}_{α}^{Q} ( s )}^{T} {V}_{β}^{Q} ( s ) d s \\ ( α , β = 1 , 2 , 3 , 4 , 5 )$$
where Ω_{Qa} is a component of a rotation vector Ω_{Q}, P(Ω_{Q},s) is a rotation matrix, R(Ω_{Q},s) is a transition matrix, and I₃ is an equivalent matrix.

9. The method of claim 1, wherein the list of the new curvature vectors (C_{Q}) of said another next frame is determined by using a semi-implicit method in computer graphics.

10. The method of claim 9, wherein, when the semi-implicit method is used, each of the model curves of a frame at every time is determined by 2N-dimension vector xₜ=(τ₁,κ₁, . . . , τ_{N},κ_{N})ₜ and a curved shape of a strand of hair (x_{t+Δt}) at a time (t+Δt) is obtained from a curved shape of a strand of hair xₜ at a time t through following equation:
x_{t+Δt}=xₜ+ty_{t+Δt}
yₜ={\dot{τ}₁,\dot{κ}₁, . . . , \dot{τ}_{N},\dot{κ}_{N}}ₜ
where Δt is a time interval and yₜ is a differential of xₜ with respect to time t.

11. The method of claim 10, wherein the y_{t+Δt} is obtained by solving a linear equation:
Ay_{t+Δt}=Byₜ+fₜ
where matrices A and B may be respectively a mass matrix and a stiffness matrix of (2N)*(2N) matrices calculated using geometric composite matrices, fₜ is a restoring force due to an elastic force of the strand of the hair, an inertial force caused by movement of a root connected to a body of the strand, an external force such as gravity or wind, and a collision force between the hair and the body of the strand or between the hair and another hair, and the composite matrices of claim 9 may be used to calculate (2N) vector fₜ.

12. The method of claim 11, wherein an algorithm for solving the linear equation comprises at least one of conjugate gradient (CG) method, Cholesky decomposition (CD), singular value decomposition (SVD), Gauss-Seidel relaxation, a multi-grid algorithm, and a preconditioned conjugate gradient (PCG) method.

13. The method of claim 1, wherein the initial curve information of the strand of the hair is three-dimension curve information in a format of a set of M sample points.

14. The method of claim 13, wherein the set of the M sample points is generated by at least one of Autodesk MAYA and Shave & Haircut or by an editor program.

15. The method of claim 1, wherein, in the generating of the list of the initial curvature vectors (C_{Q}), the list of the initial curvature vectors of the N segment curves is obtained from 3M values of initial M sample points by applying a minimizing technique to a difference function g(τ₁,κ₁, . . . , τ_{N},κ_{N}) as expressed by following equation:
$${min}_{\{ {τ}_{1} , {κ}_{1} , … , {τ}_{N} , {κ}_{N} \}} g ( {τ}_{1} , {κ}_{1} , … , {τ}_{N} , {κ}_{N} )$$
$$g ( {τ}_{1} , {κ}_{1} , … , {τ}_{N} , {κ}_{N} ) = {\sum }_{κ = 1}^{M} {\vert r ( {s}_{κ} ) - {r}_{in} ( {s}_{κ} ) \vert}^{2} ,$$
where r(s) and rᵢₙ(s) are a model curve and a sample curve respectively, r(s_{κ})−rᵢₙ(s_{κ}) is an error, and it is understood that sum of square of the error becomes the difference function g(τ₁,κ₁, . . . , τ_{N},κ_{N}).

16. An apparatus for generating a graphic hair motion, comprising:
an initializer to determine a list of initial curvature vectors by using curve information of a strand of hair;
a kinematics unit to generate a rotation vector, a rotation matrix, a transition matrix, and a model curve;
a geometry unit to generate a composite matrix using the rotation matrix and the transition matrix; and
a dynamics unit to calculate a list of new curvature vectors of a shape of a next frame based on the composite matrix and an external root motion of hair.

17. The apparatus of claim 16, wherein the geometry unit is connected to the kinematics unit and the dynamics unit such that the list of the new curvature vectors determined by the dynamics unit is used by the kinematics unit again and generates a modified hair curve according to time.
